(19) United States
(12) Patent Application Publication
(10) Pub. No.: US 2018/0279205 A1
(43) Pub. Date: Sep. 27, 2018

(54) RELAY APPARATUS AND RELAY METHOD

(71) Applicant: SoftBank Corp., Tokyo (JP)

(72) Inventors: Masahiko NANRI, Tokyo (JP); Takayuki YOSHIMURA, Tokyo (JP); Masanori NOMACHI, Tokyo (JP); Takanori TAKII, Tokyo (JP); Jumpei TAKAGI, Tokyo (JP)

(21) Appl. No.: 15/558,485

(22) PCT Filed: May 31, 2017
(86) PCT No.: PCT/JP2017/020361

§ 371 Date: Sep. 14, 2017

(30) Foreign Application Priority Data
Aug. 8, 2016 (JP) 2016-155665
Mar. 1, 2017 (JP) 2017-038755

(51) Int. Cl. H04W 48/06; H04W 48/10; H04W 24/04

(52) U.S. Cl. CPC H04W 48/06; H04W 88/08; H04W 24/04; H04W 48/10

(57) ABSTRACT

The fairness of radio communication between a donor base station and terminal devices is maintained. A relay apparatus 20 for relaying radio communication between one or more terminal devices 10 and a donor base station 30, wherein when the relay apparatus 20 receives a cell restriction instruction from the donor base station 30 to restrict a quantity of terminals capable of existing in a service area of a cell formed by the donor base station 30, the relay apparatus 20 executes processing for avoiding cell restriction operation on itself and transfers the cell restriction instruction received from the donor base station 30 to the terminal devices 10 existing in a service area of a cell formed by the relay apparatus itself.

### CROSS-REFERENCE TO RELATED APPLICATIONS

This application is based on Japanese Patent Application No. 2016-155665 filed on Aug. 8, 2016, and Japanese Patent Application No. 2017-038755 filed on Mar. 1, 2017, the contents of which are incorporated by reference herein.

### TECHNICAL FIELD

The present invention relates to a relay apparatus and relay method for relaying radio communication between a macro cell base station and terminal devices.

### BACKGROUND ART

Regarding communication for which a conventional fixed-line-compatible femto cell base station is used, communication services are provided by using fixed lines such as a public telephone network as backhaul (for example, see PTL 1). However, when the fixed lines are used as the backhaul as in PTL 1, this causes problems in that it takes time to install the fixed lines and large amounts of running costs are required for the fixed lines. In order to solve the problems in the femto cell communication using these fixed lines, it is possible to use a radio-communication-compatible femto cell base station for which radio communication using, for example, a macro cell base station is used as the backhaul (hereinafter referred to as the “relay apparatus” in order to distinguish it from the conventional fixed-line-compatible femto cell base station).

### CITATION LIST

### Patent Literature

PTL 1: Patent No. 5456874

### SUMMARY OF THE INVENTION

### Technical Problem

Meanwhile, when the radio communication is used as the backhaul, the macro cell base station treats the relay apparatus the same as a terminal device such as a mobile unit. Therefore, for example, when the macro cell base station imposes a cell restriction to restrict the quantity of terminal devices existing in a service area of a cell due to the occurrence of congestion, the relay apparatus also becomes a target of the restriction just like terminal devices. However, if the relay apparatus is restricted, all the terminal devices which exist in a service area within a communication-enabled range formed by the relay apparatus will be restricted and the fairness of the radio communication between the macro cell base station and the terminal devices will be impaired.

The present invention was devised in light of the above-described circumstances and it is an object of the invention to provide a relay apparatus capable of maintaining fairness of radio communication between a macro cell base station and terminal devices.

### Solution to Problem

In order to achieve the above-described object, the present invention includes the following constituent elements.

(1-1) A relay apparatus for relaying radio communication between one or more terminal devices and a macro cell base station, wherein when the relay apparatus receives a cell restriction instruction from the macro cell base station to restrict a quantity of terminals capable of existing in a service area of a cell formed by the macro cell base station, the relay apparatus executes processing for avoiding cell restriction operation on itself and transfers the cell restriction instruction received from the macro cell base station to the terminal devices existing in the service area of the cell formed by the relay apparatus itself.

(1-2) A relay method for relaying radio communication between one or more terminal devices and a macro cell base station, wherein the relay method includes steps, when receiving a cell restriction instruction from the macro cell base station to restrict a quantity of terminals capable of existing in a service area of a cell formed by the macro cell base station, of: executing processing for avoiding cell restriction operation on itself; and transferring the cell restriction instruction received from the macro cell base station to the terminal devices existing in the service area of the cell formed by the relay apparatus itself.

The present invention may be configured as desired as follows.

(2) The avoiding processing is to determine to not execute the cell restriction operation in response to the cell restriction instruction received from the macro cell base station.

(3) The avoiding processing is to: prohibit generation of a random number to be used to judge whether the relay apparatus itself can exist in the service area or not; and execute the judgment of whether the relay apparatus itself can exist in the service area or not by using a specific preset value so that it will be determined that the relay apparatus itself can exist in the service area.

(4) The avoiding processing is to determine to not execute the cell restriction operation in response to the cell restriction instruction received from the macro cell base station by setting, in advance, its own priority for existing in the service area higher than priorities for the terminal devices existing in the service area.

(5) If the relay apparatus has received an individual cell restriction instruction from a management server to restrict the quantity of terminals capable of existing in the service area of the cell formed by the relay apparatus itself in addition to the cell restriction instruction received from the macro cell base station when transmitting the cell restriction instruction to the terminal devices existing in the service area of the cell formed by the relay apparatus itself, the relay apparatus compares a restriction level of the cell restriction instruction with a restriction level of the individual cell restriction instruction and transmits either the cell restriction instruction or the individual cell restriction instruction, whichever has a higher restriction level, to the terminal devices existing in the service area of the cell formed by the relay apparatus itself.

(6) If the relay apparatus has received an individual cell restriction instruction from a management server to restrict the quantity of terminals capable of existing in the service area of the cell formed by the relay apparatus itself in addition to the cell restriction instruction received from the macro cell base station when transmitting the cell restriction instruction to the terminal devices existing in the service area of the cell formed by the relay apparatus itself, the relay apparatus transmits the individual cell restriction instruction received from the management server to the terminal devices existing in the service area of the cell formed by the relay apparatus itself.

### Advantageous Effects Of The Invention

When the relay apparatus according to the embodiment is employed, fairness of the radio communication between a donor base station and terminal devices can be maintained.

### BRIEF DESCRIPTION OF DRAWINGS

FIG. 1 is a configuration diagram of a mobile communications system including a relay apparatus according to an embodiment of the present invention;

FIG. 2 is a schematic diagram for explaining the status of general cell restrictions;

FIG. 3 is a schematic diagram for explaining an example of the cell restrictions when a conventional relay apparatus exists in a service area;

FIG. 4 is a schematic diagram for explaining an example of the cell restrictions when the relay apparatus according to the embodiment exists in the service area;

FIG. 5 is a schematic diagram for explaining an example of the cell restrictions when the relay apparatus according to the embodiment exists in the service area;

FIG. 6 is a schematic diagram for explaining an example of the cell restrictions when the relay apparatus according to the embodiment exists in the service area;

FIG. 7 is a flowchart for explaining a processing sequence for a relay apparatus 20 with respect to a first technique;

FIG. 8 is a flowchart for explaining a processing sequence for the relay apparatus 20 with respect to a second technique;

FIG. 9 is a flowchart for explaining a processing sequence for the relay apparatus 20 with respect to a third technique;

FIG. 10 is a flowchart for explaining a processing sequence for the relay apparatus 20 with respect to a fourth technique; and

FIG. 11 is a schematic diagram for explaining an example of the cell restrictions when the relay apparatus according to the embodiment exists in the service area.

### DESCRIPTION OF EMBODIMENTS

An embodiment according to the present invention will be explained with reference to the drawings. However, the embodiment explained below is just for illustration and is not intended to exclude applications of various variations or technologies which are not clearly specified below. In other words, the present invention can be implemented in various variations within the range not departing from the gist of the invention. Furthermore, in the following descriptions of the series of drawings, the same or similar reference numerals are assigned to the same or similar parts.

### [Configuration of Mobile Communications System]

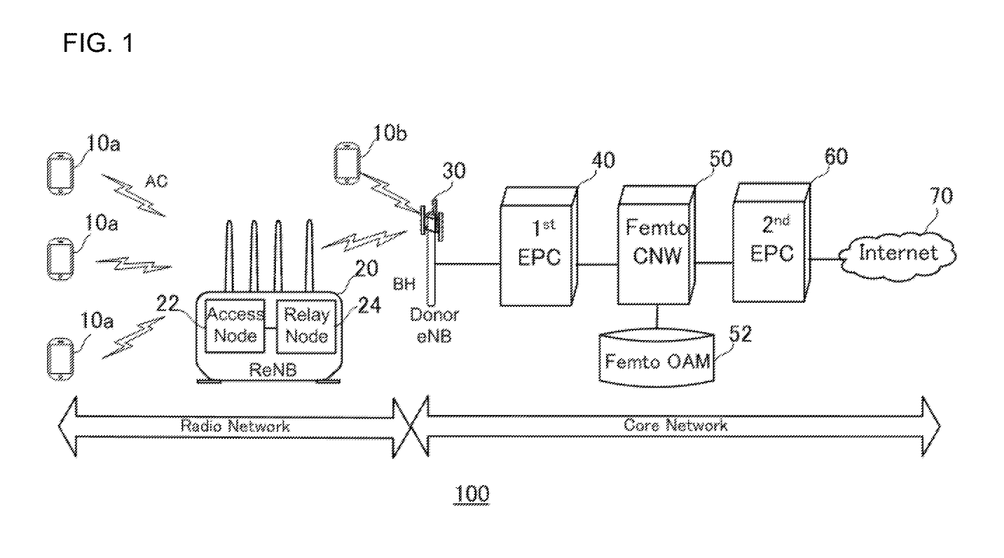

FIG. 1 illustrates a configuration diagram of a mobile communications system including a relay apparatus according to an embodiment of the present invention. A mobile communications system 100 according to this embodiment is exemplified as a mobile communications system according to the LTE scheme standardized by 3GPP and includes a radio network and a core network. The configuration of the radio network and the configuration of the core network will be sequentially explained below.

### (Configuration of Radio Network)

Referring to FIG. 1, the mobile communications system 100 includes terminal devices 10, a relay apparatus 20, and a donor base station (macro cell base station) 30 as the configuration relating to the radio network. Incidentally, the radio network is called E-UTRAN (Evolved Universal Terrestrial Radio Access Network) according to the LTE scheme.

The terminal device 10 is a mobile communications terminal such as a smartphone or a cell phone and is also called UE (User Equipment). FIG. 1 shows terminal devices 10a which exist in a service area of a cell (communication-enabled range) formed by the relay apparatus 20 and are connected to the relay apparatus 20, and a terminal device 10b which exists in a service area of a cell formed by the donor base station 30 and is connected to the donor base station 30. The terminal devices 10a and the terminal device 10b will be collectively referred to as the terminal devices 10.

The relay apparatus 20 is also called a ReNB (Repeater type eNode B) and constitutes one node in the radio network.

The relay apparatus 20 is configured by including an access node 22 and a relay node 24.

The access node 22 is also called a femto base station, establishes radio communication with the terminal device 10a, and provides the terminal device 10a with packet communication services (such as voice packet communication services and multimedia services). The radio communication between the access node 22 and the terminal device 10a is also called an access link. The cell size of a cell formed by the access node 22 is on a smaller scale than that of the donor base station 30 and constructs a communication area with a radius ranging from several meters to several tens of meters.

The access node 22 establishes radio communication with the donor base station 30 via the relay node 24. The relay node 24 is also called a CPE (Customer Premises Equipment). The radio communication between the relay node 24 and the donor base station 30 is also called backhaul (BH: Backhaul).

Incidentally, the access node 22 and the relay node 24 may be configured as separate nodes. When they are configured as the separate nodes, the relay node 24 assumes a role of the relay apparatus according to the present invention.

The donor base station 30 is also called a Donor eNB (Donor eNode B) and establishes radio communication with the relay node 24. The donor base station 30 constructs a communication area with a radius ranging from several hundreds of meters to a dozen kilometers or so.

### (Configuration of Core Network)

Referring to FIG. 1, the mobile communications system 100 includes a first core network EPC (Evolved Packet Core) 40, a femto core network 50, and a second core network EPC 60. Incidentally, this embodiment will be explained as including the first core network EPC 40 and the second core network EPC 60; however, the mobile communications system 100 may be configured by one core network EPC.

The first core network EPC 40 is connected to, for example, the donor base station 30 and has a function implementing, via the donor base station 30, mobile management and authentication of the individual terminal devices 10, and managing processing for setting packet communication data paths and a function implementing quality control in the radio network.

The femto core network 50 is a network that performs various management relating to the relay apparatus 20. The femto core network 50 is connected to, for example, a femto OAM (Femto Operations Administration Maintenance; management apparatus) 52 and has a function that operates, manages, and maintains the relay apparatus 20.

The second core network EPC 60 has, for example: a function that controls call connections to provide mobile communication services or controls the services; a function that serves as a switching station to receive calls from external networks to contract subscribers in the radio network or subscribers who are roaming in the radio network; a function that implements mobile management and authentication of the individual terminal devices 10 in the second core network EPC 60 and manages processing for setting packet communication data paths; and a function that performs communication policy control such as quality control and performs control pursuant to billing rules.

### [Regarding Cell Restrictions]

Conventional cell restrictions will be explained before explaining cell restrictions executed by the mobile communications system 100 according to this embodiment.

For example, when congestion or the like occurs in a mobile communications system according to the LTE scheme standardized by 3GPP, a donor base station (macro cell base station) is configured to transmit broadcast information including cell restriction instructions such as SIB1 (System Information Block Type 1) and SIB2 (System Information Block Type2) to all terminals existing in a service area of its own station's cell and restrict the quantity of the terminals capable of existing in the service area of its own station by using restriction parameters included in SIB1 and SIB2.

There is, for example, “cellBarred” as a restriction parameter included in SIB1. “Barred” or “not Barred,” indicating whether the cell of the donor base station is restricted or not, is stored in “cellBarred.”

There is, for example, “ac-Barring Factor” as a restriction parameter included in SIB2. A value corresponding to a restriction rate when restricting a terminal is stored in “ac-Barring Factor.” For example, when the restriction rate is 30%, “p70” indicative of “0.70” is stored; when the restriction rate is 40%, “p60” indicative of “0.60” is stored; and when the restriction rate is 60%, “p40” indicative of “0.40” is stored.

When the terminal device 10 receives the broadcast information including SIB1 and SIB2 and “cellBarred” included in SIB1 is “barred,” the terminal device 10 executes the cell restriction operation. The cell restriction operation includes, for example, generating a random number Rand with the range of [0,1), comparing the generated random number Rand with the value corresponding to “ac-Barring Factor” included in SIB2, and judging whether the terminal device can exist in the service area of the cell formed by the donor base station 30 or not. This judgment is performed as follows.

(1) When [the random number Rand<the value corresponding to ac-Barring Factor] is established, it is judged that the terminal device can exist in the service area.

(2) When [the random number Rand≥the value corresponding to ac-Barring Factor] is established, it is judged that the terminal device cannot exist in the service area.

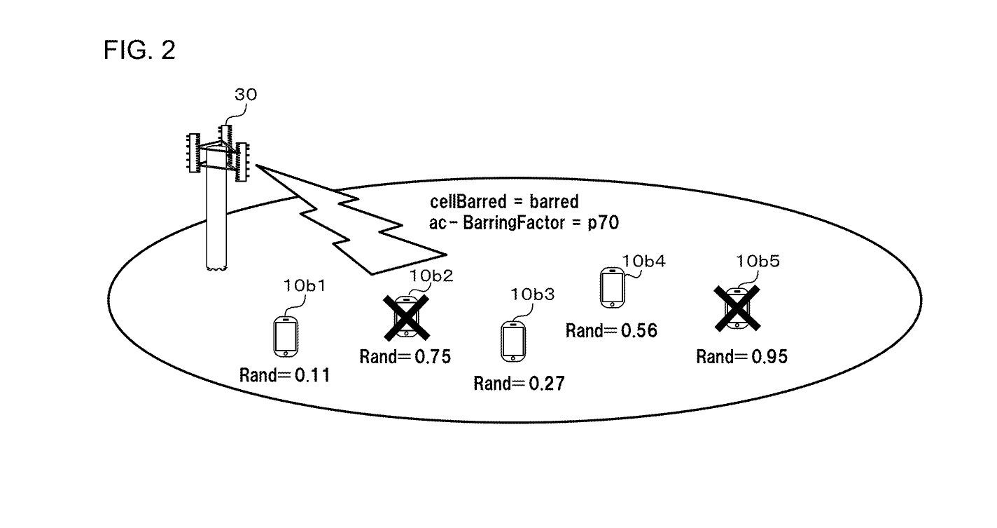

A specific explanation will be given by referring to FIG. 2. FIG. 2 is a diagram which illustrates the status of cell restrictions when “cellBarred” is “barred” indicating that the cell of the donor base station 30 is restricted, and “ac-Barring Factor” is “p70” indicating a 30% restriction rate.

In this case, the random number Rand of terminal device 10b1 is “0.11,” the random number Rand of terminal device 10b2 is “0.75,” the random number Rand of terminal device 10b3 is “0.27,” the random number Rand of terminal device 10b4 is “0.56,” and the random number Rand of terminal device 10b5 is “0.95.”

Therefore, it is judged that the three terminal devices 10b1, 10b3, 10b4 which have generated the random numbers Rand that are less than the value “0.70” corresponding to “ac-Barring Factor=p70” can exist in the service area. Meanwhile, it is judged that the two terminal devices 10b2, 10b5 which have generated the random numbers Rand that are more than the value “0.70” corresponding to “ac-Barring Factor=p70” cannot exist in the service area.

By executing the cell restrictions, the terminal devices corresponding to 30% of the terminal devices which exist in the service area of the cell of the donor base station 30 are restricted as terminal devices which cannot exist in the service area.

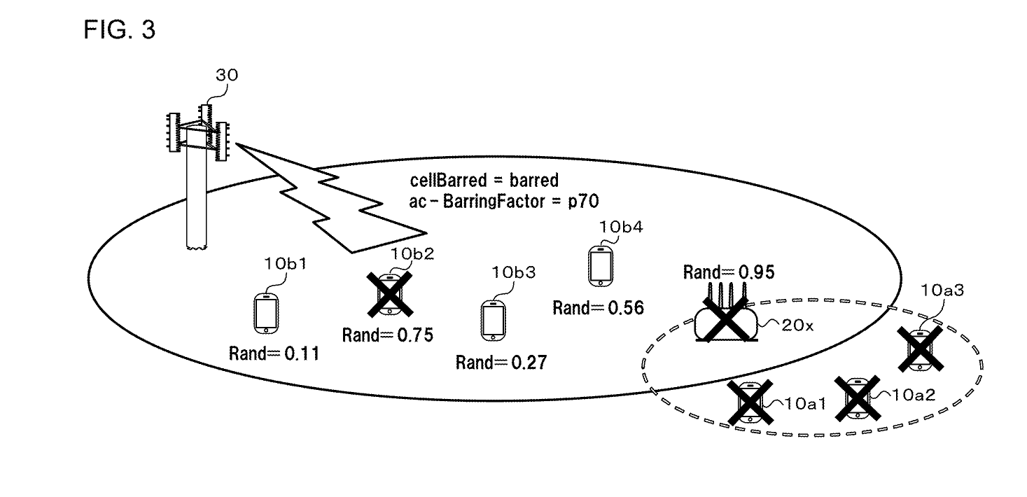

FIG. 3 is a diagram which illustrates an example of a case where when broadcast information similar to that in FIG. 2 is transmitted, a conventional relay apparatus 20x, instead of the terminal device 10b5 in FIG. 2, exists in the service area of the cell of the donor base station 30.

In this case, the random number Rand of the relay apparatus 20x is “0.95.” The value “0.95” is more than the value “0.70” corresponding to “ac-Barring Factor=p70.” Therefore, it is judged that the relay apparatus 20x cannot exist in the service area and becomes a restricted target.

Once the communication of the relay apparatus 20x is restricted, all terminal devices 10a1, 10a2, 10a3 which exist in the service area of the cell of the relay apparatus 20x become no longer capable of communication and each terminal device 10a1, 10a2, 10a3 can no longer benefit from services. Specifically speaking, in this case, the fairness of the radio communication with the terminal devices 10b1 to 10b4 which directly exist in the service area of the donor base station 30 will be impaired.

In order to avoid the above-described circumstance, the inventors of the present application have considered various techniques and have come to think of four techniques. These four techniques will be called a first technique, a second technique, a third technique, and a fourth technique and be sequentially explained below.

### (First Technique)

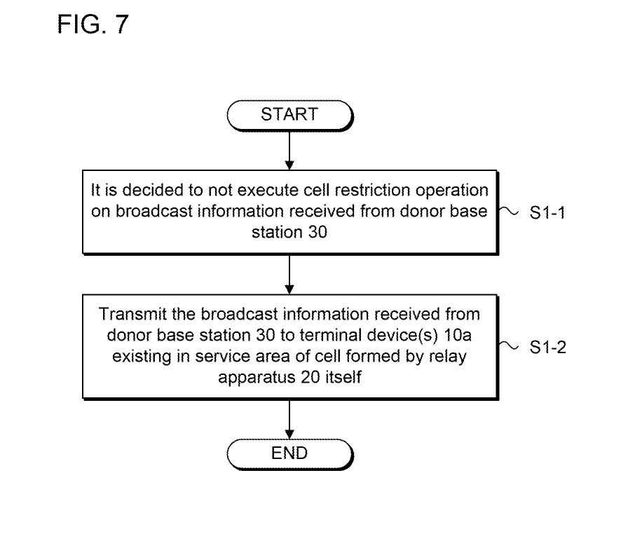

When receiving the broadcast information including SIB1 and SIB2 (cell restriction instructions), the relay apparatus 20 according to the first technique proceeds with processing in accordance with, for example, the procedures illustrated in FIG. 7.

(S1-1) It is determined to not execute the aforementioned cell restriction operation in response to the broadcast information including SIB1 and SIB2 received from the donor base station 30.

In other words, even if “cellBarred” included in SIB1 of the received broadcast information is “barred,” the relay apparatus 20 does not generate the random number and does not perform the judgment on whether or not it can exist in the service area of the cell formed by the donor base station 30. As a result, the relay apparatus 20 remains to exist in the service area of the cell formed by the donor base station 30.

(S1-2) The relay apparatus 20 transmits (including transfer) the broadcast information including SIB1 and SIB2 received from the donor base station 30 to the terminal devices 10a which exist in the service area of the cell formed by the relay apparatus 20 itself.

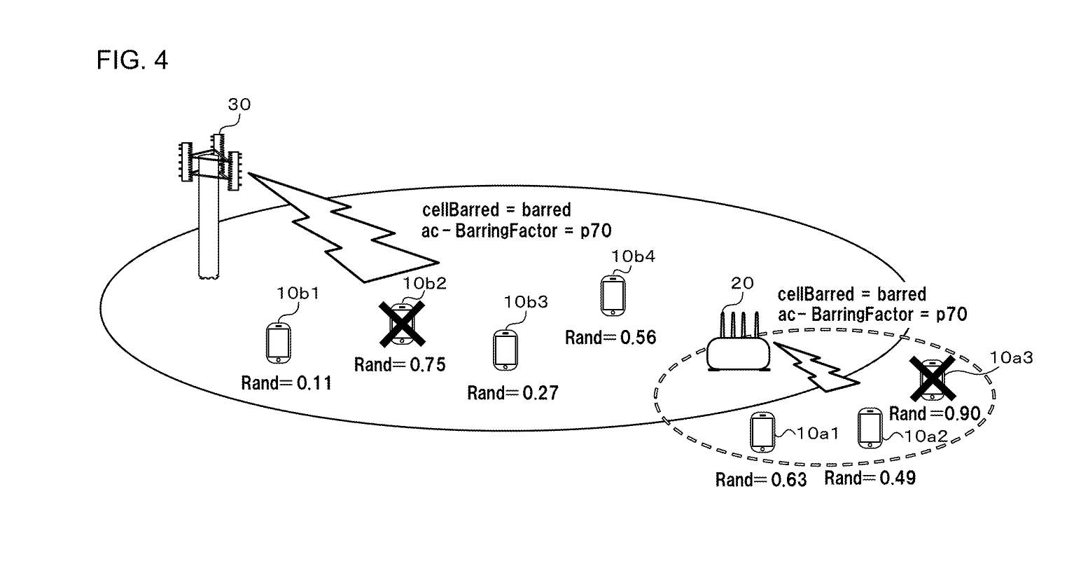

A specific explanation will be given by referring to FIG. 4. FIG. 4 is a diagram which illustrates an example of a case where when broadcast information similar to that in FIG. 3 is transmitted, the relay apparatus 20 which adopts the first technique, instead of the conventional relay apparatus 20x illustrated in FIG. 3, exists in the service area of the cell of the donor base station 30.

In this case, when the relay apparatus 20 receives the broadcast information including SIB1 and SIB2 from the donor base station 30, it does not generate the random number and does not perform the judgment on whether or not it can exist in the service area of the cell formed by the donor base station 30. Instead, the relay apparatus 20 transmits the broadcast information including SIB1 and SIB2 received from the donor base station 30 to all the terminal devices 10a1, 10a2, 10a3 which exist in the service area of the cell formed by the relay apparatus 20 itself.

In response, the terminal devices 10a1, 10a2, and 10a3 generate the random numbers based on the broadcast information including SIB1 and SIB2 received from the relay apparatus 20. Referring to FIG. 4, the random number Rand of the terminal device 10a1 is “0.63,” the random number Rand of the terminal device 10a2 is “0.49,” and the random number Rand of the terminal device 10a3 is “0.90.”

Accordingly, it is judged that the two terminal devices 10a1 and 10a2 which have generated the random numbers Rand that are less than the value “0.70” corresponding to “ac-Barring Factor=p70” can exist in the service area. Meanwhile, it is judged that the terminal device 10a3 which has generated the random number Rand more than the value “0.70” corresponding to “ac-Barring Factor=p70” cannot exist in the service area.

By executing the cell restrictions in the above-described manner, the terminal device(s) corresponding to 30% of the terminal devices 10b which exist in the service area of the cell of the donor base station 30 and the terminal device(s) corresponding to 30% of the terminal devices 10a which exist in the service area of the cell of the relay apparatus 20 are restricted respectively as terminal devices which cannot exist in the service area. Therefore, the fairness of the radio communication between the donor base station 30 and the terminal devices 10 can be maintained.

### (Second Technique)

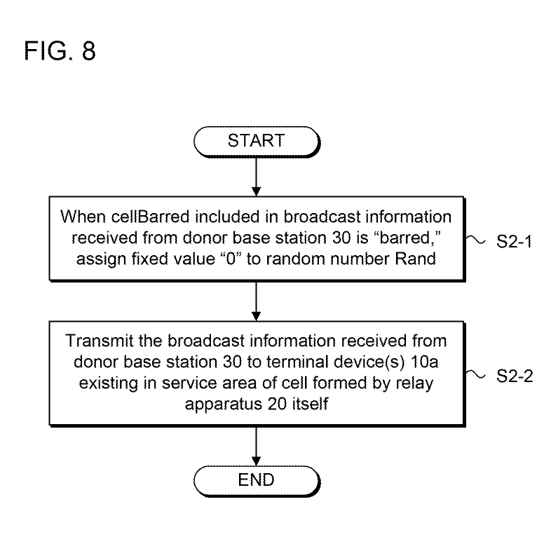

When receiving the broadcast information including SIB1 and SIB2, the relay apparatus 20 according to the second technique proceeds with processing in accordance with, for example, the procedures illustrated in FIG. 8.

(S2-1) When “cellBarred” included in SIB1 is “barred,” the relay apparatus 20 does not generate the random number and assigns a fixed value “0” to the random number Rand. Then, the relay apparatus 20 compares the random number Rand, to which “0” is assigned, with the value corresponding to “ac-Barring Factor” included in SIB2 and judges whether it can exist in the service area of the cell formed by the donor base station 30. In this case, since the value of the random number Rand is fixed to “0,” the value of the random number Rand always becomes smaller than the value corresponding to “ac-Barring Factor,” and the judgment result indicating that it can exist in the service area will be always obtained.

In other words, when “cellBarred” included in SIB1 of the received broadcast information is “barred,” the relay apparatus 20 does not generate the random number and performs the judgment on whether or not it can exist in the service area of the cell formed by the donor base station 30 by using “0,” which is a preset specified value, so that it will be judged that it can exist in the service area. Accordingly, it will be judged that the relay apparatus 20 can exist in the service area of the cell formed by the donor base station 30, so that the relay apparatus 20 remains to exist in the service area of the cell formed by the donor base station 30.

(S2-2) The relay apparatus transmits (including transfer) the broadcast information including SIB1 and SIB2 received from the donor base station 30 to the terminal devices 10a which exist in the service area of the cell formed by the relay apparatus 20 itself.

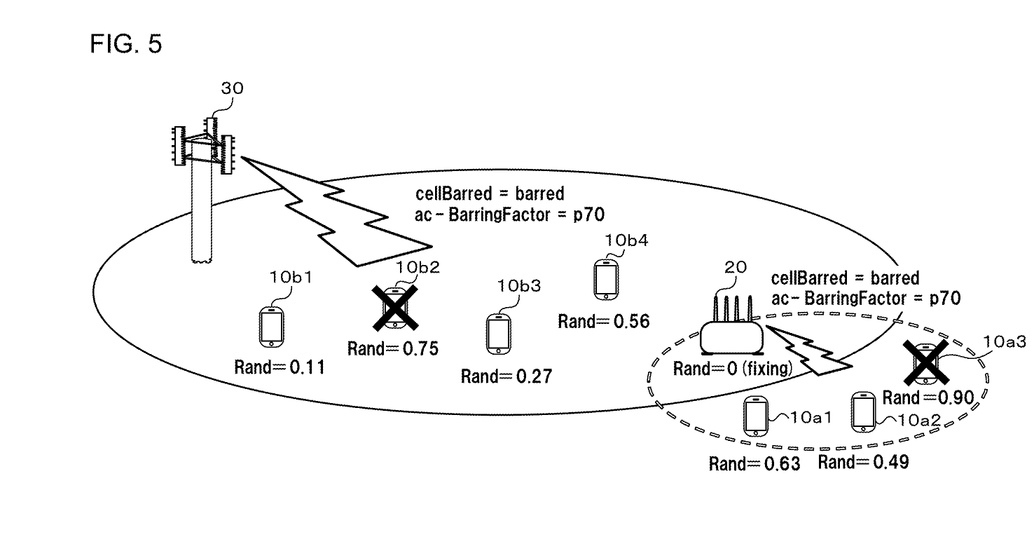

A specific explanation will be given by referring to FIG. 5. FIG. 5 is a diagram which illustrates an example of a case where when broadcast information similar to that in FIG. 3 is transmitted, the relay apparatus 20 which adopts the second technique, instead of the conventional relay apparatus 20x illustrated in FIG. 3, exists in the service area of the cell of the donor base station 30.

In this case, when the relay apparatus 20 receives the broadcast information including SIB1 and SIB2 from the donor base station 30, the relay apparatus 20 does not generate the random number, but assigns the fixed value “0” to the random number Rand. Since “0” is less than the value “0.70” corresponding to “ac-Barring Factor=p70,” it is judged that the relay apparatus 20 can exist in the service area of the cell of the donor base station 30.

Furthermore, the relay apparatus 20 transmits the broadcast information including SIB1 and SIB2 received from the donor base station 30 to all the terminal devices 10a1, 10a2, 10a3 which exist in the service area of the cell formed by the relay apparatus 20 itself.

In response, the terminal devices 10a1, 10a2, and 10a3 generate random numbers based on the broadcast information including SIB1 and SIB2 received from the relay apparatus 20. Referring to FIG. 5, the random number Rand of the terminal device 10a1 is “0.63,” the random number Rand of the terminal device 10a2 is “0.49,” and the random number Rand of the terminal device 10a3 is “0.90.”

Accordingly, it is judged that the two terminal devices 10a1 and 10a2 which have generated the random numbers Rand that are less than the value “0.70” corresponding to “ac-Barring Factor=p70” can exist in the service area. Meanwhile, it is judged that the terminal device 10a3 which has generated the random number Rand more than the value “0.70” corresponding to “ac-Barring Factor=p70” cannot exist in the service area.

By executing the cell restrictions in the above-described manner, the terminal device(s) corresponding to 30% of the terminal devices 10b which exist in the service area of the cell of the donor base station 30 and the terminal device(s) corresponding to 30% of the terminal devices 10a which exist in the service area of the cell of the relay apparatus 20 are restricted respectively as terminal devices which cannot exist in the service area. Therefore, the fairness of the radio communication between the donor base station 30 and the terminal devices 10 can be maintained.

### (Third Technique)

The relay apparatus 20 according to the third technique is based on the premise that any one or more of “11” to “15” is preset as an access class (AC) as described later.

The access class herein used is priority identification information that is set to terminals such as the terminal device 10 and the relay apparatus 20 and is information assigned to each terminal by operating personnel or the like in advance. The standard specifications for the 3GPP specify, as access codes, “0” to “9” which are assigned to general terminals, “10” which is assigned when reporting an emergency, and “11” to “15” which are assigned to special terminals.

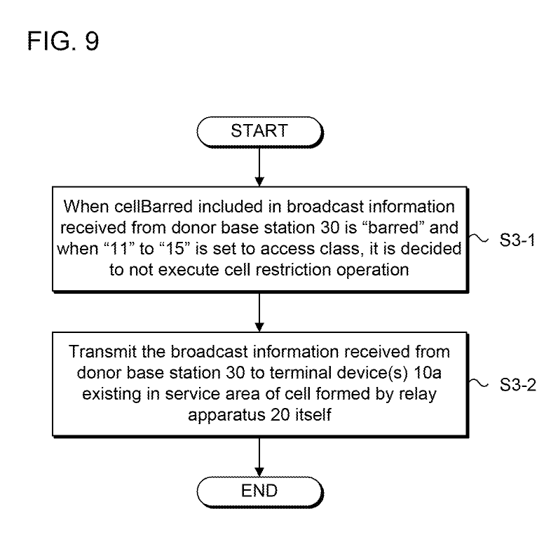

When receiving the broadcast information including SIB1 and SIB2 from the donor base station 30, the relay apparatus 20 according to the third technique proceeds with processing, for example, in accordance with the procedures illustrated in FIG. 9.

(S3-1) When “cellBarred” included in SIB1 is “barred,” the relay apparatus 20 judges whether any one of “11” to “15” is set to the access class or not; and if any one of “11” to “15” is set to the access class, the relay apparatus 20 determines to not execute the aforementioned cell restriction operation.

In other words, when any one of “11” to “15” is set to the access class, the relay apparatus 20 does not generate the random number and does not perform the judgment on whether or not it can exist in the service area of the cell formed by the donor base station 30 even if “cellBarred” included in SIB1 of the broadcast information received from the donor base station 30 is “barred.” As a result, the relay apparatus 20 remains to exist in the service area of the cell formed by the donor base station 30.

(S3-2) The relay apparatus 20 transmits (including transfer) the broadcast information including SIB1 and SIB2 received from the donor base station 30 to the terminal devices 10a which exist in the service area of the cell formed by the relay apparatus 20 itself.

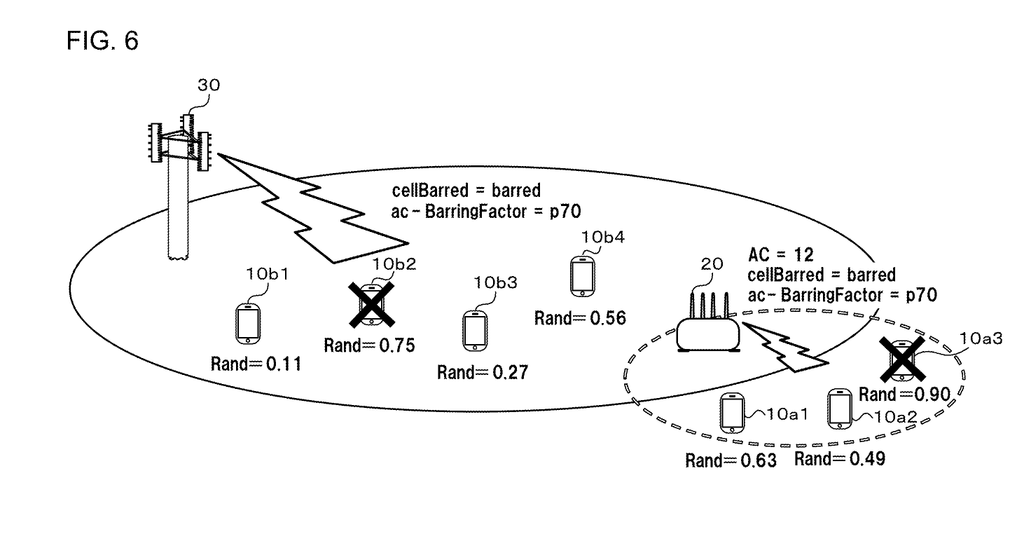

A specific explanation will be given by referring to FIG. 6. FIG. 6 is a diagram which illustrates an example of a case where when broadcast information similar to that in FIG. 3 is transmitted, and the relay apparatus 20 which adopts the third technique, instead of the conventional relay apparatus 20x illustrated in FIG. 3, exists in the service area of the cell of the donor base station 30.

In this case, “12” is set to the access class (AC) of the relay apparatus 20. So, when receiving the broadcast information including SIB1 and SIB2 from the donor base station 30, the relay apparatus 20 does not generate the random number and does not perform the judgment on whether or not it can exist in the service area of the cell formed by the donor base station 30. Instead, the relay apparatus 20 transmits the broadcast information including SIB1 and SIB2 received from the donor base station 30 to all the terminal devices 10a1, 10a2, and 10a3 which exist in the service area of the cell formed by the relay apparatus 20 itself.

In response, the terminal devices 10a1, 10a2, and 10a3 generate the random numbers on the basis of the broadcast information including SIB1 and SIB2 received from the relay apparatus 20. Referring to FIG. 6, the random number Rand of the terminal device 10a1 is “0.63,” the random number Rand of the terminal device 10a2 is “0.49,” and the random number Rand of the terminal device 10a3 is “0.90.”

Accordingly, it is judged that the two terminal devices 10a1 and 10a2 which have generated the random numbers Rand that are less than the value “0.70” corresponding to “ac-Barring Factor=p70” can exist in the service area. Meanwhile, it is judged that the terminal device 10a3 which has generated the random number Rand more than the value “0.70” corresponding to “ac-Barring Factor=p70” cannot exist in the service area.

By executing the cell restrictions in the above-described manner, the terminal device(s) corresponding to 30% of the terminal devices 10b which exist in the service area of the cell of the donor base station 30 and the terminal device(s) corresponding to 30% of the terminal devices 10a which exist in the service area of the cell of the relay apparatus 20 are restricted respectively as terminal devices which cannot exist in the service area. Therefore, the fairness of the radio communication between the donor base station 30 and the terminal devices 10 can be maintained.

### (Fourth Technique)

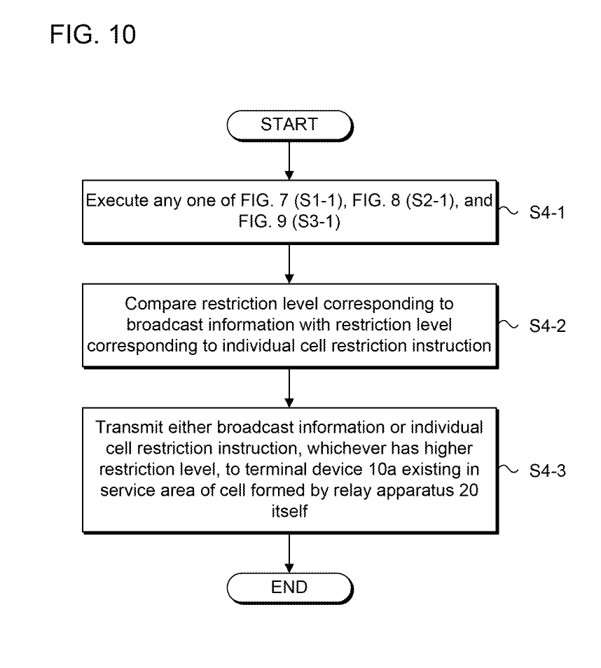

When the relay apparatus 20 according to the fourth technique has received an individual cell restriction instruction from the femto OAM 52 in addition to the broadcast information, which has been received by the relay apparatus 20 according to, for example, the first technique, the second technique, or the third technique from the donor base station 30, when transmitting the broadcast information to the terminal devices 10a which exist in the service area of the cell formed by itself, the relay apparatus 20 proceeds with processing in accordance with for example, the procedures illustrated in FIG. 10. The individual cell restriction instruction herein used is a cell restriction instruction which is a demand made by the femto OAM 52 to each relay apparatus 20 individually. This individual cell restriction instruction is an instruction to restrict the quantity of the terminal devices 10a capable of existing in the service area of the cell formed by the relay apparatus 20 itself, and includes a restriction rate which represents a restriction level by using a numerical value.

(S4-1) The relay apparatus 20 executes any one of the aforementioned (S1-1), the aforementioned (S2-1), or the aforementioned (S3-1).

Accordingly, even if “cellBarred” included in SIB1 of the received broadcast information is “barred,” the relay apparatus 20 remains to exist in the service area of the cell formed by the donor base station 30.

(S4-2) The relay apparatus 20 compares the restriction level corresponding to the broadcast information received from the donor base station 30 with the restriction level corresponding to the individual cell restriction instruction received from the femto OAM 52. For example, the restriction rate determined by a value corresponding to “ac-Barring Factor” included in SIB2 can be used as the restriction level.

(S4-3) As a result of the comparison in (S4-2) above, the relay apparatus 20 adopts whichever restriction level is higher, and transmits (including transfer) either the broadcast information or the individual cell restriction instruction corresponding to the adopted restriction level to the terminal devices 10a which exist in the service area of the cell formed by the relay apparatus 20 itself. In other words, the relay apparatus 20 transmits either the broadcast information or the individual cell restriction instruction, whichever has a higher restriction level, to the terminal devices 10a which exist in the service area of the cell formed by the relay apparatus 20 itself.

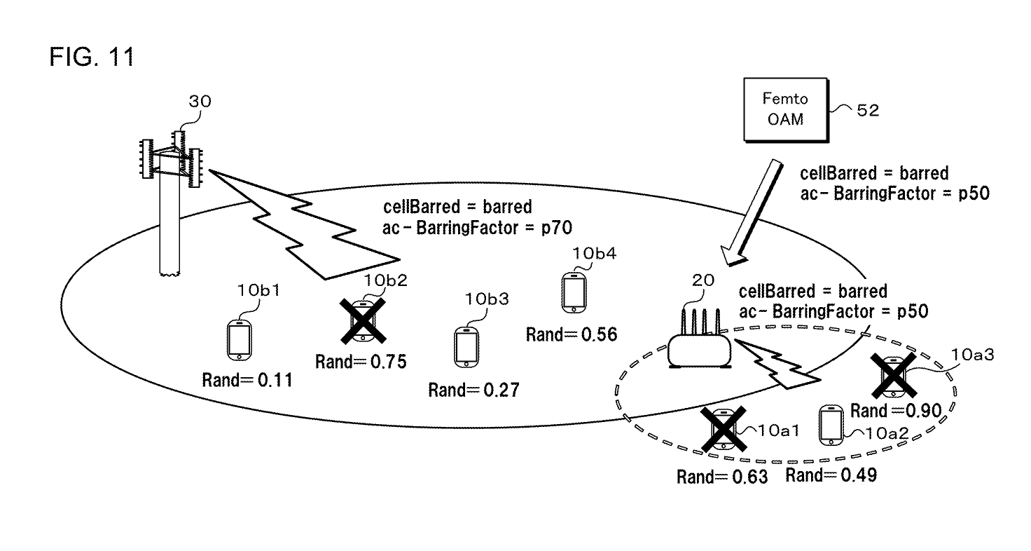

A specific explanation will be given by referring to FIG. 11. FIG. 11 is a diagram which illustrates an example of a case where when broadcast information similar to that in FIG. 3 is transmitted, the relay apparatus 20 which adopts the fourth technique, instead of the conventional relay apparatus 20x illustrated in FIG. 3, exists in the service area of the cell of the donor base station 30.

In this case, when receiving the broadcast information including SIB1 and SIB2 from the donor base station 30, the relay apparatus 20 executes any one of the aforementioned (S1-1), the aforementioned (S2-1), or the aforementioned (S3-1). Then, the relay apparatus 20 compares the restriction level (30% restriction rate) corresponding to the broadcast information received from the donor base station 30 with the restriction level (50% restriction rate) corresponding to the individual cell restriction instruction received from the femto OAM 52.

As a result of the comparison of the restriction levels, the relay apparatus 20 finds that the restriction level corresponding to the individual cell restriction instruction is higher. So, the relay apparatus 20 transmits the individual cell restriction instruction received from the femto OAM 52 to all the terminal devices 10a1, 10a2, and 10a3 which exist in the service area of the cell formed by the relay apparatus 20 itself.

In response, the terminal devices 10a1, 10a2, and 10a3 generate the random numbers on the basis of the individual cell restriction instruction received from the relay apparatus 20. Referring to FIG. 11, the random number Rand of the terminal device 10a1 is “0.63,” the random number Rand of the terminal device 10a2 is “0.49,” and the random number Rand of the terminal device 10a3 is “0.90.”

Accordingly, it is judged that the one terminal device 10a2 which has generated the random number Rand that is less than the value “0.50” corresponding to “ac-Barring Factor=p50” can exist in the service area. Meanwhile, it is judged that the terminal devices 10a1 and 10a3 which have generated the random numbers Rand more than the value “0.50” corresponding to “ac-Barring Factor=p50” cannot exist in the service area.

By executing the cell restrictions in the above-described manner, the terminal device(s) corresponding to 30% of the terminal devices 10b which exist in the service area of the cell of the donor base station 30 and the terminal device(s) corresponding to 50% of the terminal devices 10a which exist in the service area of the cell of the relay apparatus 20 are restricted respectively as terminal devices which cannot exist in the service area. Such cell restrictions are particularly effective under the circumstance where, for example, the quantity of the terminal devices 10a which exist in the service area of the cell of the relay apparatus 20 is relatively larger than the quantity of the terminal devices 10b which exist in the service area of the cell of the donor base station 30. This is because the possibility of avoiding a congested state can be enhanced by increasing only the restriction rate on the terminal devices 10a which exist in the service area of the cell of the relay apparatus 20.

Therefore, under the circumstance where the cell of a specific relay apparatus 20 is particularly crowded, it becomes possible to avoid the congested state and maintain the fairness of the radio communication between the donor base station 30 and the terminal devices 10 by transmitting the individual cell restriction instruction to the relay apparatus 20 and increasing only the restriction rate of the terminal devices 10a which exist in the service area of the cell of the relay apparatus 20.

Incidentally, regarding the above-described fourth technique, the restriction level corresponding to the broadcast information received from the donor base station 30 is compared with the restriction level corresponding to the individual cell restriction instruction received from the femto OAM 52; however, the comparison of the restriction levels may be omitted. For example, when receiving the individual cell restriction instruction from the femto OAM 52, the relay apparatus 20 may prioritize that individual cell restriction instruction and transmit the individual cell restriction instruction to all the terminal devices 10a1, 10a2, and 10a3 which exist in the service area of the cell formed by the relay apparatus 20 itself.

Accordingly, by setting the restriction level which can avoid the congestion efficiently in the individual cell restriction instruction and transmitting that individual cell restriction instruction to the specific relay apparatus 20, it becomes possible to consider the balance between the quantity of the terminal devices 10b which exist in the service area of the cell of the donor base station 30 and the quantity of the terminal devices 10a which exist in the service area of the cell of the relay apparatus 20 and to apply the restrictions according to the respective circumstances. Therefore, it becomes possible to avoid the congested state efficiently and maintain the fairness of the radio communication between the donor base station 30 and the terminal devices 10.

Furthermore, regarding the aforementioned fourth technique or a variation example, a setting may be set so that whether or not to adopt the individual cell restriction instruction received from the femto OAM 52 can be set. In this case, for example, when the setting is set to adopt the individual cell restriction instruction with respect to the aforementioned first technique, the aforementioned second technique, or the aforementioned third technique, the relay apparatus 20 may proceed with the processing in accordance with the procedures for the aforementioned fourth technique or its variation example.

### [Advantageous Effects of This Embodiment]

When the relay apparatus 20 according to the embodiment as explained above receives the broadcast information including SIB1 and SIB2 (the cell restriction instructions) from the donor base station 30, the relay apparatus 20 can execute processing for avoiding the cell restriction operation on itself and transmit the broadcast information including SIB1 and SIB2 received from the donor base station 30 to the terminal devices 10a which exist in the service area of the cell formed by itself.

Furthermore, when the relay apparatus 20 receives the individual cell restriction instruction from the femto OAM 52 in addition to the broadcast information received from the donor base station 30, it can also transmit the individual cell restriction instruction received from the femto OAM 52 to the terminal devices 10a which exist in the service area of the cell formed by itself.

Accordingly, when the cell restrictions occur at the donor base station 30, it is possible to restrict the terminal device 10a, which exists in the service area of the cell formed by the donor base station 30, according to the restriction rate, maintain the relay apparatus 20 to exist in the service area of the cell formed by the donor base station 30, and restrict the terminal device 10b, which exists in the service area of the cell formed by the relay apparatus 20, according to the restriction rate.

Therefore, when the relay apparatus 20 according to the embodiment is employed, fairness of the radio communication between the donor base station 30 and the terminal devices 10 can be maintained.

[Other Embodiments]The present invention has been described by referring to the aforementioned embodiment; however, it should not be understood that the descriptions and diagrams which constitute part of this disclosure limit this invention. This disclosure should make various substitute embodiments, examples, and operation technologies apparent to those skilled in the art.

For example, the mobile communications system according to the LTE scheme was taken as an example and explained in the aforementioned embodiment; however, the present invention is not limited to this example and can be also applied to other communication schemes and communication schemes to be established in the future.

### INDUSTRIAL APPLICABILITY

The relay apparatus according to the present invention is suited for maintaining fairness of the radio communication between a macro cell base station and terminal devices.

### REFERENCE SIGNS LIST

10 terminal device
20 relay apparatus
22 access node
24 relay node
30 donor base station (macro cell base station)
40 first core network EPC
50 femto core network
52 femto OAM
60 second core network EPC
100 mobile communications system

1. A relay apparatus for relaying radio communication between one or more terminal devices and a macro cell base station,
wherein when the relay apparatus receives a cell restriction instruction from the macro cell base station to restrict a quantity of terminals capable of existing in a service area of a cell formed by the macro cell base station, the relay apparatus executes processing for avoiding cell restriction operation on itself and transfers the cell restriction instruction received from the macro cell base station to the terminal devices existing in a service area of a cell formed by the relay apparatus itself.

2. The relay apparatus according to claim 1,
wherein the avoiding processing is to determine to not execute the cell restriction operation in response to the cell restriction instruction received from the macro cell base station.

3. The relay apparatus according to claim 1,
wherein the avoiding processing is to: prohibit generation of a random number to be used to judge whether the relay apparatus itself can exist in the service area or not; and execute the judgment of whether the relay apparatus itself can exist in the service area or not by using a specific preset value so that it will be determined that the relay apparatus itself can exist in the service area.

4. The relay apparatus according to claim 1,
wherein the avoiding processing is to determine to not execute the cell restriction operation in response to the cell restriction instruction received from the macro cell base station by setting, in advance, its own priority for existing in the service area higher than priorities for the terminal devices existing in the service area.

5. The relay apparatus according to claim 1,
wherein if the relay apparatus has received an individual cell restriction instruction from a management server to restrict the quantity of terminals capable of existing in the service area of the cell formed by the relay apparatus itself in addition to the cell restriction instruction received from the macro cell base station when transmitting the cell restriction instruction to the terminal devices existing in the service area of the cell formed by the relay apparatus itself, the relay apparatus compares a restriction level of the cell restriction instruction with a restriction level of the individual cell restriction instruction and transmits either the cell restriction instruction or the individual cell restriction instruction, whichever has a higher restriction level, to the terminal devices existing in the service area of the cell formed by the relay apparatus itself.

6. The relay apparatus according to claim 2,
wherein if the relay apparatus has received an individual cell restriction instruction from a management server to restrict the quantity of terminals capable of existing in the service area of the cell formed by the relay apparatus itself in addition to the cell restriction instruction received from the macro cell base station when transmitting the cell restriction instruction to the terminal devices existing in the service area of the cell formed by the relay apparatus itself, the relay apparatus compares a restriction level of the cell restriction instruction with a restriction level of the individual cell restriction instruction and transmits either the cell restriction instruction or the individual cell restriction instruction, whichever has a higher restriction level, to the terminal devices existing in the service area of the cell formed by the relay apparatus itself.

7. The relay apparatus according to claim 3,
wherein if the relay apparatus has received an individual cell restriction instruction from a management server to restrict the quantity of terminals capable of existing in the service area of the cell formed by the relay apparatus itself in addition to the cell restriction instruction received from the macro cell base station when transmitting the cell restriction instruction to the terminal devices existing in the service area of the cell formed by the relay apparatus itself, the relay apparatus compares a restriction level of the cell restriction instruction with a restriction level of the individual cell restriction instruction and transmits either the cell restriction instruction or the individual cell restriction instruction, whichever has a higher restriction level, to the terminal devices existing in the service area of the cell formed by the relay apparatus itself.

8. The relay apparatus according to claim 4,
wherein if the relay apparatus has received an individual cell restriction instruction from a management server to restrict the quantity of terminals capable of existing in the service area of the cell formed by the relay apparatus itself in addition to the cell restriction instruction received from the macro cell base station when transmitting the cell restriction instruction to the terminal devices existing in the service area of the cell formed by the relay apparatus itself, the relay apparatus compares a restriction level of the cell restriction instruction with a restriction level of the individual cell restriction instruction and transmits either the cell restriction instruction or the individual cell restriction instruction, whichever has a higher restriction level, to the terminal devices existing in the service area of the cell formed by the relay apparatus itself.

9. The relay apparatus according to claim 1,
wherein if the relay apparatus has received an individual cell restriction instruction from a management server to restrict the quantity of terminals capable of existing in the service area of the cell formed by the relay apparatus itself in addition to the cell restriction instruction received from the macro cell base station when transmitting the cell restriction instruction to the terminal devices existing in the service area of the cell formed by the relay apparatus itself, the relay apparatus transmits the individual cell restriction instruction received from the management server to the terminal devices existing in the service area of the cell formed by the relay apparatus itself.

10. The relay apparatus according to claim 2,
wherein if the relay apparatus has received an individual cell restriction instruction from a management server to restrict the quantity of terminals capable of existing in the service area of the cell formed by the relay apparatus itself in addition to the cell restriction instruction received from the macro cell base station when transmitting the cell restriction instruction to the terminal devices existing in the service area of the cell formed by the relay apparatus itself, the relay apparatus transmits the individual cell restriction instruction received from the management server to the terminal devices existing in the service area of the cell formed by the relay apparatus itself.

11. The relay apparatus according to claim 3,
wherein if the relay apparatus has received an individual cell restriction instruction from a management server to restrict the quantity of terminals capable of existing in the service area of the cell formed by the relay apparatus itself in addition to the cell restriction instruction received from the macro cell base station when transmitting the cell restriction instruction to the terminal devices existing in the service area of the cell formed by the relay apparatus itself, the relay apparatus transmits the individual cell restriction instruction received from the management server to the terminal devices existing in the service area of the cell formed by the relay apparatus itself.

12. The relay apparatus according to claim 4,
wherein if the relay apparatus has received an individual cell restriction instruction from a management server to restrict the quantity of terminals capable of existing in the service area of the cell formed by the relay apparatus itself in addition to the cell restriction instruction received from the macro cell base station when transmitting the cell restriction instruction to the terminal devices existing in the service area of the cell formed by the relay apparatus itself, the relay apparatus transmits the individual cell restriction instruction received from the management server to the terminal devices existing in the service area of the cell formed by the relay apparatus itself.

13. The relay apparatus according to claim 1,
wherein the cell restriction operation includes: generating a random number to be used to judge whether the relay apparatus itself can exist in the service area or not; comparing the random number with a value corresponding to a restriction rate included in the cell restriction instruction; and judging whether the relay apparatus itself can exist in the service area with respect to the cell formed by the macro cell base station.

14. A relay method for relaying radio communication between one or more terminal devices and a macro cell base station,
the relay method comprising steps, when receiving a cell restriction instruction from the macro cell base station to restrict a quantity of terminals capable of existing in a service area of a cell formed by the macro cell base station, of:
executing processing for avoiding cell restriction operation on itself; and
transferring the cell restriction instruction received from the macro cell base station to the terminal devices existing in a service area of a cell formed by the relay apparatus itself.
